(19) United States
(12) Patent Application Publication
(10) Pub. No.: US 2026/0159916 A1
(43) Pub. Date: Jun. 11, 2026

(54) METHOD OF METAL RECOVERY

(71) Applicant: Alderley Gold Corp., Vancouver (CA)

(72) Inventors: Randy Earl Buffington, Elko, NV (US); Art Sabio Ibrado, Tucson, AZ (US); Alan Nigel Pangbourne, West Vancouver (CA)

(73) Assignee: Alderley Gold Corp., Vancouver (CA)

(21) Appl. No.: 19/314,086

(22) Filed: Aug. 29, 2025

Related U.S. Application Data
(60) Provisional application No. 63/691,234, filed on Sep. 5, 2024.

(51) Int. Cl. C22B 11/00; C22B 1/00; C22B 1/16; C22B 3/12; C22B 3/16; C22B 3/44; C22B 11/02

(52) U.S. Cl. CPC C22B 11/04; C22B 1/005; C22B 1/16; C22B 3/12; C22B 3/1616; C22B 3/44; C22B 11/02

(57) ABSTRACT

A method of recovering a metal, the method comprising: physically processing the material; curing the material; contacting the material with an alkali and/or oxidizing agent; contacting the material with a lixiviant to form a pregnant leach solution; and separating the metal from the pregnant leach solution. The method may further comprise agglomerating the material. The alkali may comprise a carbonate, sodium hydroxide, or a combination thereof. The method may further comprise regenerating the sodium hydroxide. The metal may be a precious metal.

### CROSS-REFERENCE TO RELATED APPLICATIONS

This application claims priority to and the benefit of the filing of U.S. Provisional Patent Application No. 63/691,234, entitled “METHOD OF METAL RECOVERY”, filed on Sep. 5, 2024, and the specification and claims thereof are incorporated herein by reference.

### BACKGROUND OF THE INVENTION

### Field of the Invention (Technical Field)

The present invention relates to the recovery of metal from a material.

### BACKGROUND

Methods for metal recovery from a material have traditionally required the use of lixiviants such as cyanide to extract a metal, e.g., gold, from the material. Hydrometallurgical methods of metal recovery are relatively low-cost compared to pyro-metallurgical method due to the reduced energy requirements. However, hydrometallurgical methods require longer extraction times, which reduces the efficiency of the metal recovery. What is needed is a method by which to increase the rate of metal recovery without requiring large energy inputs.

### BRIEF SUMMARY OF THE INVENTION

Embodiments of the present invention relate to a method of recovering a metal, the method comprising: physically processing a material; contacting the material with an alkali solution; oxidizing the material; regenerating an alkali; recycling the regenerated alkali to the alkali solution; contacting the material with a lixiviant to form a pregnant leach solution; and separating the metal from the pregnant leach solution. In another embodiment, the method further comprises agglomerating the material. In another embodiment, the alkali comprises a carbonate. In another embodiment, the alkali comprises sodium hydroxide.

In another embodiment, the metal is a precious metal. In another embodiment, physically processing comprises crushing. In another embodiment, physically processing comprises high-pressure grinding rolls. In another embodiment, oxidizing the material comprises contacting the material with an oxidizer. In another embodiment, the lixiviant comprises cyanide.

In another embodiment, regenerating an alkali comprises producing sodium sulfate. In another embodiment, regenerating an alkali further comprises contacting sodium sulfate with calcium hydroxide to yield sodium hydroxide. In another embodiment, regenerating an alkali further comprises contacting sodium bicarbonate with sodium hydroxide to yield sodium carbonate. In another embodiment, regenerating an alkali further comprises contacting sodium sulfate with calcium hydroxide to yield hydrous calcium sulfate. In another embodiment, the regenerated alkali is sodium hydroxide.

In another embodiment, the material comprises igneous rock. In another embodiment, the method further comprises curing the material. In another embodiment, the alkali solution comprises more sodium carbonate compared to sodium hydroxide. In another embodiment, the method further comprises producing bicarbonate. In another embodiment, the method further comprises contacting the material with a calcium compound. In another embodiment, the method further comprises precipitating an oxidation product from the alkali solution.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a diagram showing a process flow diagram for metal recovery, according to an embodiment of the present invention;

FIG. 2 is a diagram showing a process flow diagram for metal recovery and reagent regeneration, according to an embodiment of the present invention;

FIG. 3 is a diagram showing a process flow diagram for reagent regeneration, according to an embodiment of the present invention;

FIG. 4 is a diagram showing an extraction system, according to an embodiment of the present invention;

FIG. 5 is a diagram showing a process flow diagram for heap and tank oxidation extraction, according to an embodiment of the present invention;

FIG. 6 is a table showing a comparison between a known process for extraction and a heap oxidation process for extraction, according to an embodiment of the present invention;

FIG. 7 is a graph showing massive intrusive gold-bearing material oxidized in the presence of sodium carbonate, according to an embodiment of the present invention;

FIG. 8 is a graph showing massive intrusive gold-bearing material oxidized in the presence of sodium hydroxide, according to an embodiment of the present invention;

FIG. 9 is a graph showing massive intrusive gold-bearing material oxidized in the presence of mixed alkalis, according to an embodiment of the present invention;

FIG. 10 is a graph showing massive intrusive gold-bearing material oxidized in the presence of simplified mixed alkalis, according to an embodiment of the present invention;

FIG. 11 is a graph showing massive intrusive gold-bearing material oxidized in the presence of sodium hydroxide, an alkali mixture, or a simplified alkali mixture, according to an embodiment of the present invention;

FIG. 12 is a graph showing gold extraction of massive intrusive gold-bearing material oxidized in the presence of sodium carbonate and a simplified alkali mixture, according to an embodiment of the present invention;

FIG. 13 is a graph showing silver extraction of massive intrusive gold-bearing material oxidized in the presence of sodium carbonate and a simplified alkali mixture, according to an embodiment of the present invention;

FIG. 14 is a graph showing gold extraction of massive intrusive gold-bearing material oxidized in the presence of an alkali mixture, according to an embodiment of the present invention;

FIG. 15 is a graph showing silver extraction of massive intrusive gold-bearing material oxidized in the presence of an alkali mixture, according to an embodiment of the present invention;

FIG. 16 is a graph showing intrusive breccia gold-bearing material oxidized in the presence of sodium carbonate, according to an embodiment of the present invention;

FIG. 17 is a graph showing intrusive breccia gold-bearing material oxidized in the presence of sodium hydroxide, according to an embodiment of the present invention;

FIG. 18 is a graph showing intrusive breccia gold-bearing material oxidized in the presence of an alkali mixture, according to an embodiment of the present invention;

FIG. 19 is a graph showing intrusive breccia gold-bearing material oxidized in the presence of a simplified alkali mixture, according to an embodiment of the present invention; and

FIG. 20 is a graph showing intrusive breccia gold-bearing material oxidized in the presence of sodium hydroxide, an alkali mixture, or a simplified alkali mixture, according to an embodiment of the present invention.

### DETAILED DESCRIPTION OF THE INVENTION

Embodiments of the present invention relate to a method of recovering a metal, the method comprising: physically processing the material; curing the material; contacting the material with an alkali and/or oxidizing agent (e.g., O₂ and/or a source of ion (e.g., Fe³⁺)); contacting the material with a lixiviant to form a pregnant leach solution; and separating the metal from the pregnant leach solution. The method may further comprise agglomerating the material. The alkali may comprise a carbonate, sodium hydroxide, or a combination thereof. The method may further comprise regenerating the sodium hydroxide and sodium bicarbonate. The metal may be a precious metal.

The method may comprise a hydrometallurgical process for the recovery of metal from a material using an alkali. Compared with recovery without the use of an alkali, the use of an alkali has several advantages including, but not limited to: oxidizing and/or catalyzing the oxidation of the material. The use of an alkali may enhance the recovery of metal from the material. The use of an alkali may be used in combination with gold extraction by cyanidation and thiourea. The alkali may be regenerated by adding lime to create sodium hydroxide. Sodium carbonate and lime are cheaper than sodium hydroxide and therefore, it is economically beneficial to regenerate sodium hydroxide with cheaper reagents.

The method does not rely on the use of an elevated temperature due to autoclaving or pyrometallurgical techniques, although in an alternative embodiment, heating may be provided. This method allows metal recovery to be enhanced without compromising other operating parameters.

The beneficial effects from the alkalis include, but are not limited to, directly or indirectly oxidizing the material surface and/or interior; and/or enhancing metal recovery following extraction by a lixiviant, e.g., cyanide or thiourea.

The term “alkali(s)” as used herein means a basic, ionic salt of an alkali metal or an alkaline earth metal. The alkali may include, but is not limited to, soda ash; trona; lime; carbonate and salts thereof; bicarbonate and salts thereof; hydroxide salts thereof; an oxide, e.g., calcium oxide; or a combination thereof. For example, an alkali may include, but is not limited to, sodium carbonate, sodium bicarbonate, sodium hydroxide, or ammonium hydroxide. The alkali may be in the form of a solution or aqueous solution. The alkalis may be a plurality of alkalis in the form of mixed alkalis or an alkali mixture. Mixed alkalis or an alkali mixture may be a solution comprising a plurality of different alkalis. The mixed alkali or alkali mixture may be in the form of a solution or aqueous solution. The plurality of different alkalis, e.g., sodium hydroxide and carbonate, may be in any ratio with respect to each other.

The terms “simplified mixed alkali(s)” or “a simplified alkali mixture” as used herein mean a single alkali used to contact a material cured with a carbonate. For example, a simplified sodium hydroxide mixture is a solution of sodium hydroxide contacted with a material cured with calcium carbonate.

The term “massive intrusive” means a quartz diorite intrusive rock that has been subject to hydrothermal alteration so that it is composed mainly of quartz, sericite and sulfides.

The term “intrusive breccia” means a variable mixture of coarse to fine grained, angular fragments of massive intrusive and sedimentary rocks which is typically matrix supported

The terms “sediment” or “sedimentary” as used herein means thin to thick bedded, fine to medium grained sandstone with common interbedded shale horizons and with variable amounts of organic carbon.

The term “metal(s)” includes any metal atom, element, ion, salt, compound, isotope, or a combination thereof. The metal may include, but is not limited to, neodymium (“Nd”), praseodymium (“Pr”), dysprosium (“Dy), copper (“Cu”), lithium (“Li”), sodium (“Na”), magnesium (“Mg”), potassium (“K”), calcium (“Ca”), titanium (“Ti”), vanadium (“V”), chromium (“Cr”), manganese (“Mn”), iron (“Fe”), cobalt (“Co”), nickel (“Ni”), cadmium (“Cd”), zinc (“Zn”), aluminum (“AI”), silicon (“Si”), silver (“Ag”), tin (“Sn”), platinum (“Pt”), gold (“Au”), bismuth (“Bi”), lanthanum (“La”), europium (“Eu”), gallium (“Ga”), scandium (“Sc”), strontium (“Sr”), yttrium (“Y”), zirconium (“Zr”), niobium (“Nb”), molybdenum (“Mo”), ruthenium (“Ru”), rhodium (“Rh”), palladium (“Pd”), indium (“In”), hafnium (“Hf”), tantalum (“Ta”), tungsten (“W”), rhenium (“Re”), osmium (“Os”), iridium (“Ir”), mercury (“Hg”), lead (“Pb”), polonium (“Po”), cerium (“Ce”), samarium (“Sm”), erbium (“Er”), ytterbium (“Yb”), thorium (“Th”), uranium (“U”), plutonium (“Pu”), terbium (“Tb”), promethium (“Pm”), tellurium (“Te”), or a combination thereof.

The term “precious metal(s)” as used herein refers to any suitable metal or combination thereof that does not comprise a base metal (e.g., copper or nickel). Suitable base metals may include, but are not limited to, gold, silver, platinum, a platinum group metal (“PGM”), or a combination thereof.

The term “base metal(s)” as used herein refers to any suitable metal or combination thereof that does not comprise a precious metal (e.g., gold or platinum). Suitable base metals may include, but are not limited to, copper, nickel, iron, aluminum, lead, zinc, tin, tungsten (also sometimes referred to as wolfram), molybdenum, tantalum, magnesium, cobalt, bismuth, cadmium, titanium, zirconium, antimony, manganese, beryllium, chromium, germanium, vanadium, gallium, hafnium, indium, niobium (also sometimes referred to as columbium), rhenium, thallium, and a combination thereof.

The term “recovery” as used herein means a process used to liberate, extract, free, or remove metal or metals from a material.

The term “material(s)” as used herein means any material bearing or comprising a metal. The material may include, but is not limited to, ore, concentrate, run of mill, tailings, or a combination thereof. The material may include, but is not limited to, igneous, metamorphic, sedimentary rock, or a combination thereof. The material may comprise breccia, intrusive or sediment rock, monomineralic material, or a combination thereof. The material may comprise a sulfide and/or telluride-containing material including, not limited to, pyrite, arsenic-bearing pyrite, arsenian pyrite, marcasite, enargite, pyrrhotite, arsenopyrite, chalcopyrite, sphalerite, galena, silicon refractory, preg-robbing with carbonaceous matter, or a combination thereof. The material comprising the metal may comprise a refractory ore.

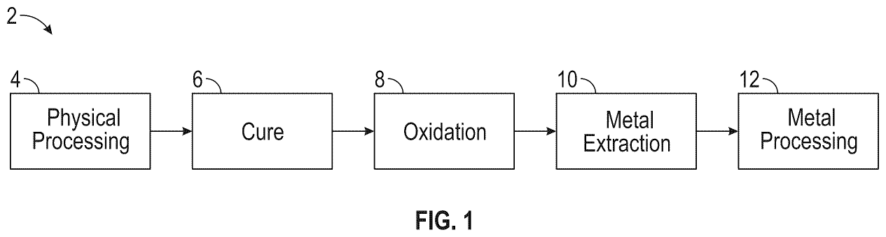

Turning now to the Figures, FIG. 1 shows metal recovery process flow diagram 2. Material undergoes physical processing 4 followed by cure 6. Physical processing 4 may comprise crushing, grinding, milling, comminuting, high-pressure grinding rolls (“HPGR”), or a combination thereof. Curing 6 comprises contacting the material with an alkali and/or oxidizing agent, e.g., O₂ and/or air. Following curing 6, the material undergoes oxidation 8. Oxidation 8 comprises contacting the material with an alkali and an oxidizer, e.g., oxygen. Subsequent to oxidation 8, the material undergoes metal extraction 10. Metal extraction 10 comprises contacting the material with a lixiviant, e.g., cyanide, to extract the metal. The metal is subjected to metal processing 12, which may comprise, for example, solvent extraction and electrowinning.

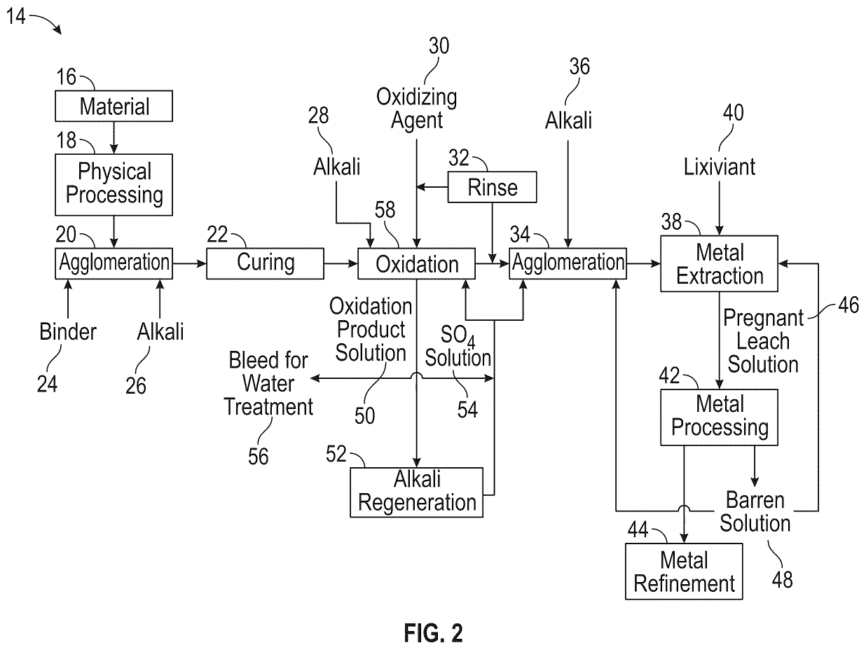

FIG. 2 shows metal recovery and reagent regeneration process flow diagram 14. Material 16 is subjected to physical processing 18 followed by agglomeration 20. The agglomerated material undergoes agglomeration 20 with alkali 26. Alkali 26 includes Na₂CO₃ and may include, but is not limited to, NaOH, CaO, or a combination thereof. Optionally, the material may be agglomerated with binder 24. The agglomerated material undergoes curing 22 followed by oxidation 58 by contact with an alkali 28 and oxidizing agent 30. Oxidizing agent 30 may comprise O₂ and may directly or indirectly oxidize material. Alkali 28 includes NaOH and may include, but is not limited to, Na₂CO₃, CaO, Ca(OH)₂ or a combination thereof. Oxidizing agent 30 may include, but is not limited to, O₂ or air. A rinse solution 32 may be contacted with the material 16 during oxidation 58 or following oxidation 58 prior to agglomeration 34. Oxidized material undergoes agglomeration 34 with alkali 36. Alkali 36 includes CaO and may include, but is not limited to NaOH, Na₂CO₃, or a combination thereof.

Oxidation 58 and/or material 16 consumes alkali during oxidation 58. Oxidation product solution 50 and SO₄ solution 54 are produced from oxidation 58 that is returned to oxidation 58. Optionally, oxidation product solution 50 and SO₄ solution 54 are bled for water treatment 56. Part of oxidation product solution 50 and SO₄ solution 54 undergoes alkali regeneration 52 to regenerate alkali solution. Regenerated alkali is returned to oxidation 58 and/or agglomeration 34. Optionally, fresh alkali is added to oxidation 58 continuously or in batches. Material from agglomeration 34 undergoes metal extraction 38 wherein lixiviant 40 is contacted with the material 16. Metal extraction 38 may comprise cyanidation to extract gold. Metal extraction 38 yields pregnant leach solution 46 which undergoes metal processing 42 to separate the metal from the solution. Metal processing 42 yields barren solution 48 that is returned to agglomeration 34 and/or metal extraction 38. Optionally, metal produced from metal processing 42 may undergo metal refinement 44 to generate a purified product, e.g., a gold bar or plate.

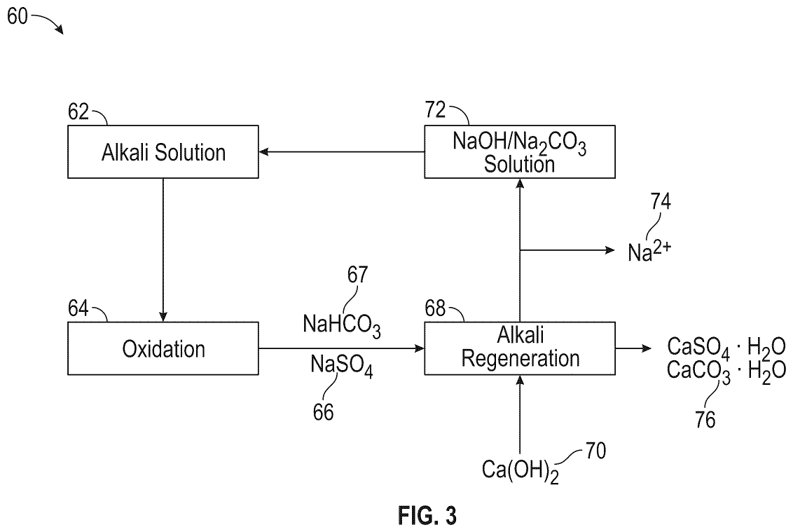

FIG. 3 shows reagent regeneration process flow diagram 60. Alkali solution 62 comprising NaOH, NaHCO₃ and Na₂CO₃ is contacted with material during oxidation 64. Oxidation 64 consumes alkali (e.g., NaOH) and produces NaSO₄ 66 and NaHCO₃67. NaSO₄ 66 and NaHCO₃67 is contacted with Ca(OH)₂ 70 during alkali regeneration 68 to yield NaOH and Na₂CO₃ solution 72 and hydrous CaSO₄ and CaSO₃ 76. Optionally, Na²⁺ 74 is bled from the reaction. NaOH and Na₂CO₃ solution 72 is returned to alkali solution 62. Optionally, NaSO₄ 66 and NaHCO₃67 produced during oxidation 64 passes through alkali regeneration 68. NaSO₄ 66 and NaHCO₃67 may be bled off after NaOH regeneration 68 and/or recycled to alkali solution 62 and/or oxidation 64.

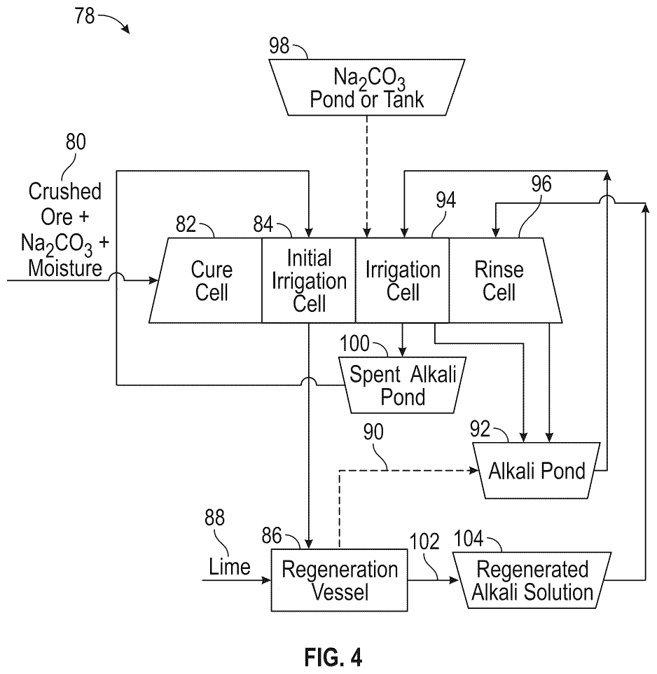

FIG. 4 shows oxidation system 78. Input 80 comprising crushed material (e.g., ore), Na₂CO₃, and moisture enters cure cell 82. Material in cure cell 82 is contacted with an alkali to cure the material. Cure cell 82 is transitioned to initial irrigation cell 84 where the material is contacted with spent alkali solution from the spent alkali solution pond 100. Alkali solution exiting initial irrigation cell 84 enters regeneration vessel 86 where it is contacted with lime 88 to yield regenerated alkali solution 102 that is stored in the regenerated alkali solution pond 104. Initial irrigation cell 84 is transitioned to irrigation cell 94. Irrigation cell 94 may comprise a plurality of individual cells. Material in irrigation cell 94 is contacted with alkali solution from alkali solution pond 92. Optionally, material in irrigation cell 94 is contacted with Na₂CO₃ from Na₂CO₃ pond or tank 98. Irrigation cell 94 is transitioned to rinse cell 96. Material in rinse cell 96 is contacted with regenerated alkali solution 102. Alkali solution from irrigation cell 94 and rinse cell 96 enters alkali pond 92. Optionally, NaOH from regeneration vessel 86 enters alkali pond 92 according to path 90. Optionally, alkali from irrigation cell 94 enters spent alkali pond 100 and is used for the initial rinse into initial irrigation cell 84.

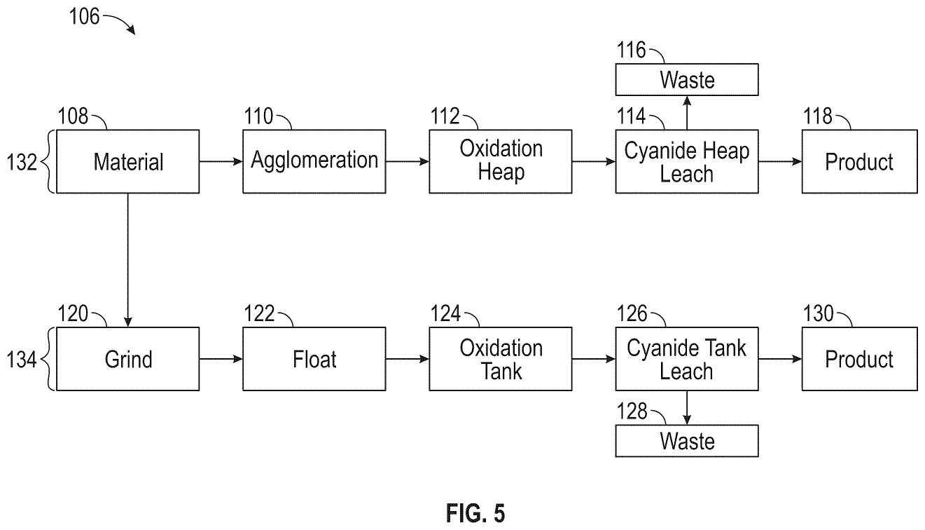

FIG. 5 shows heap and tank oxidation extraction flow diagrams 106. Extraction flow diagrams 106 show heap oxidation metal recovery method 132 and tank oxidation metal recovery method 134. Heap oxidation metal recovery method 132 shows material 108 undergo agglomeration 110 and enter oxidation heap 112. Material oxidized by oxidation heap 112 enters cyanide heap leach 114. Product 118 and waste 116 exit cyanide heap leach 114. Tank oxidation metal recovery method 134 shows material 108 undergo grind 120. Ground material then undergoes float 122. Material leaves float 122 and enters oxidation tank 124 where it is oxidized and neutralized. Material oxidized by oxidation tank 124 enters cyanide tank leach 126. Product 130 and waste 128 exit cyanide tank leach 126.

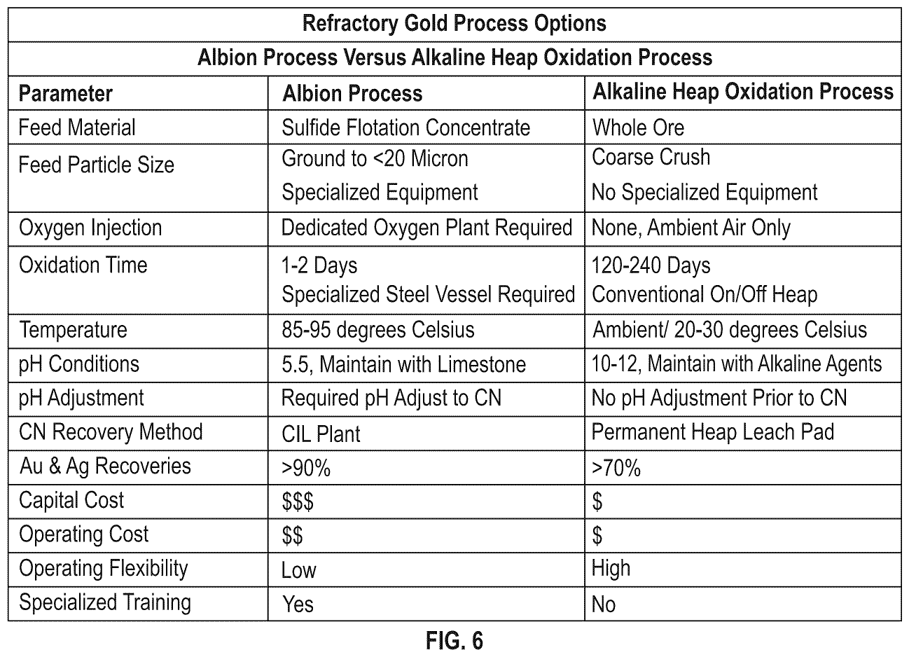

FIG. 6 shows a table comparing the Albion extraction process and a heap oxidation extraction process. The heap oxidation process uses whole ore, coarser material, no specialized equipment, lower pressure, and lower temperature compared to the Albion process.

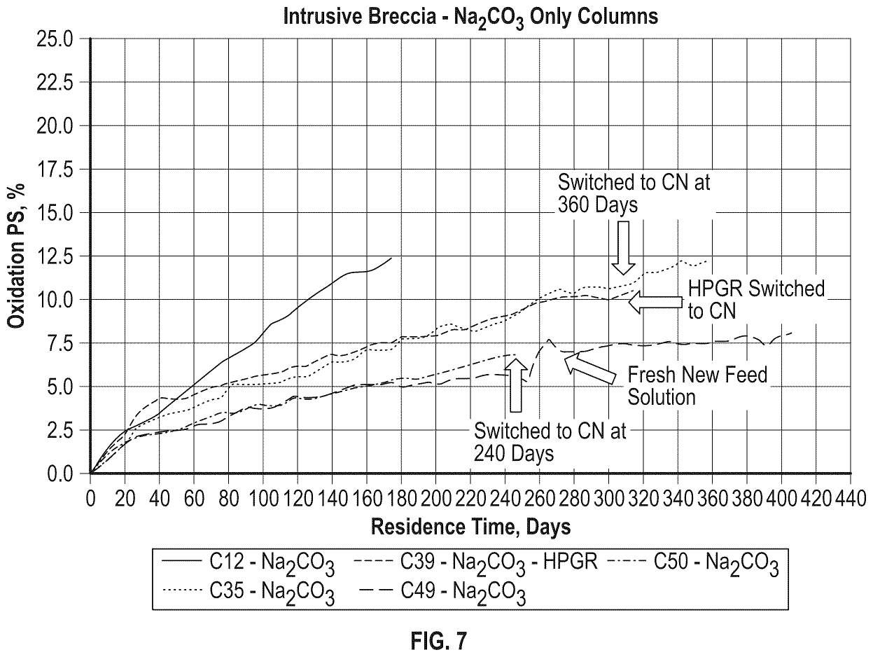

FIG. 7 shows massive intrusive breccia gold-bearing material oxidized in the presence of sodium carbonate. All massive intrusive columns exhibit a level of oxidization by sodium carbonate. The addition of fresh feed solution, e.g., fresh sodium carbonate results in an increase in the amount of material oxidized, oxidation rate, and/or degree of oxidation. Without being limited to a particular theory, the increase in the amount of material oxidized, oxidation rate, and/or degree of oxidation may be due to reduction of the common ion effect.

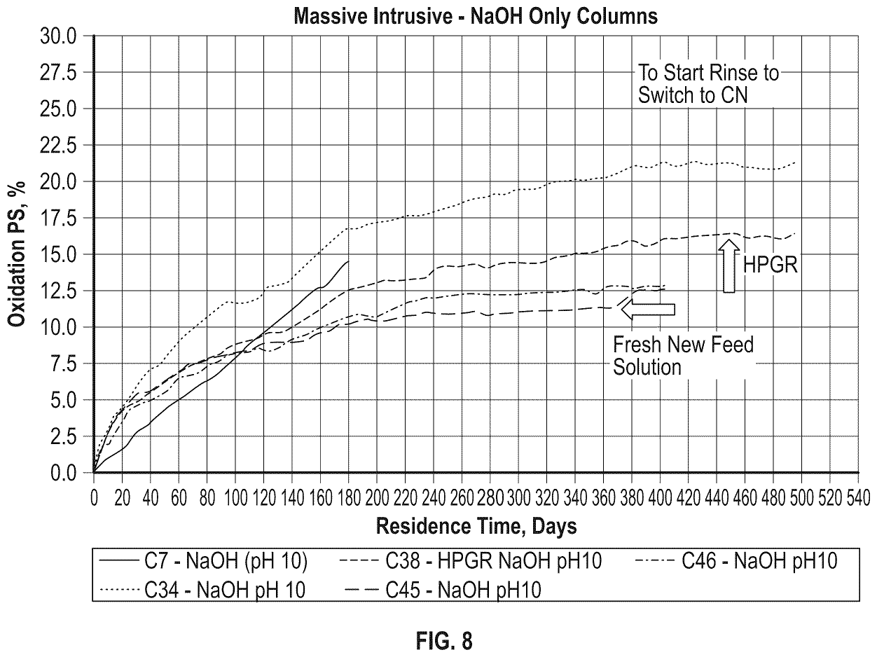

FIG. 8 shows massive intrusive gold-bearing material oxidized in the presence of sodium hydroxide. All massive intrusive columns exhibit a level of oxidization by sodium hydroxide. The addition of fresh feed solution, e.g., fresh sodium hydroxide results in an increase in the amount of material oxidized.

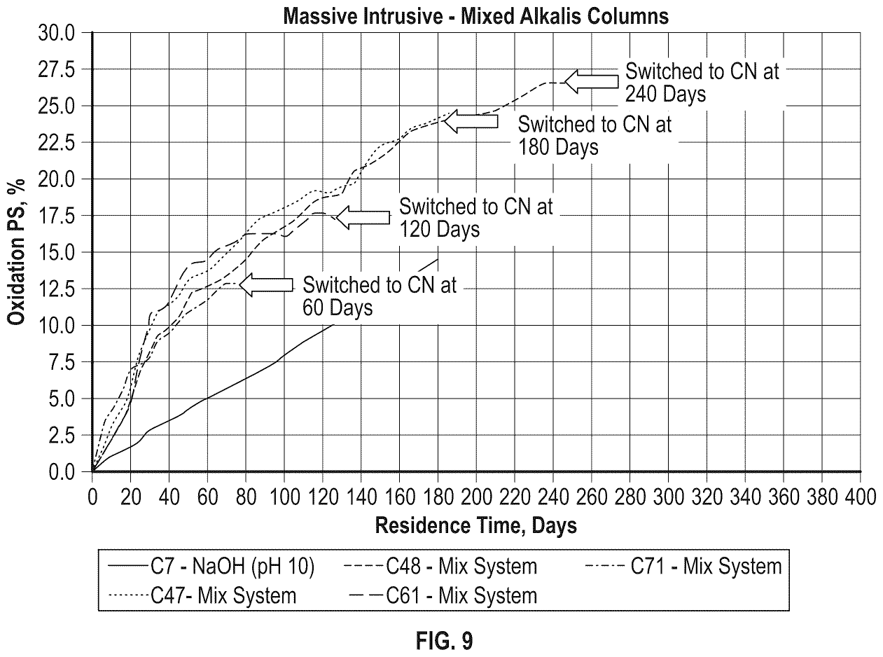

FIG. 9 shows massive intrusive gold-bearing material oxidized in the presence of mixed alkalis. All massive intrusive columns exhibit a level of oxidization by the mixed alkali solution.

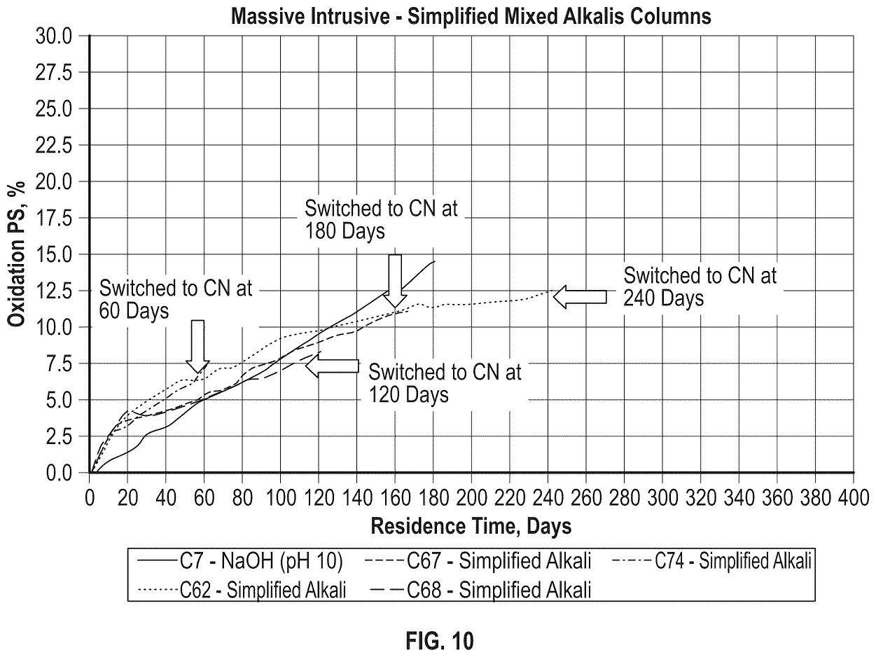

FIG. 10 shows massive intrusive gold-bearing material oxidized in the presence of simplified mixed alkalis. All massive intrusive columns exhibit a level of oxidization by the simplified mixed alkali solution.

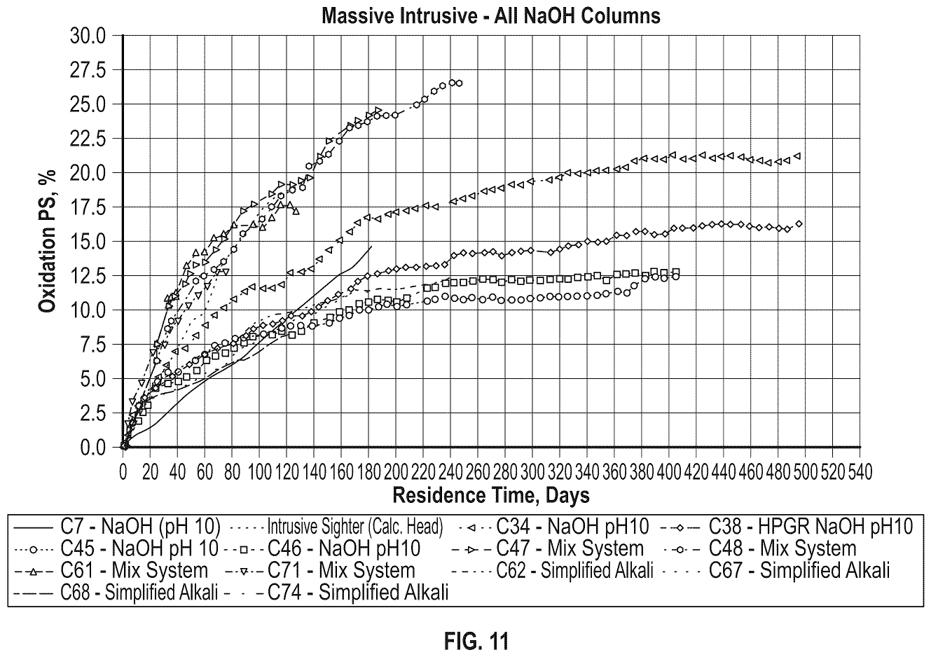

FIG. 11 shows massive intrusive gold-bearing material oxidized in the presence of sodium hydroxide, an alkali mixture, or a simplified alkali mixture. All massive intrusive columns exhibit a level of oxidization by the sodium hydroxide, alkali mixture, or simplified alkali mixture.

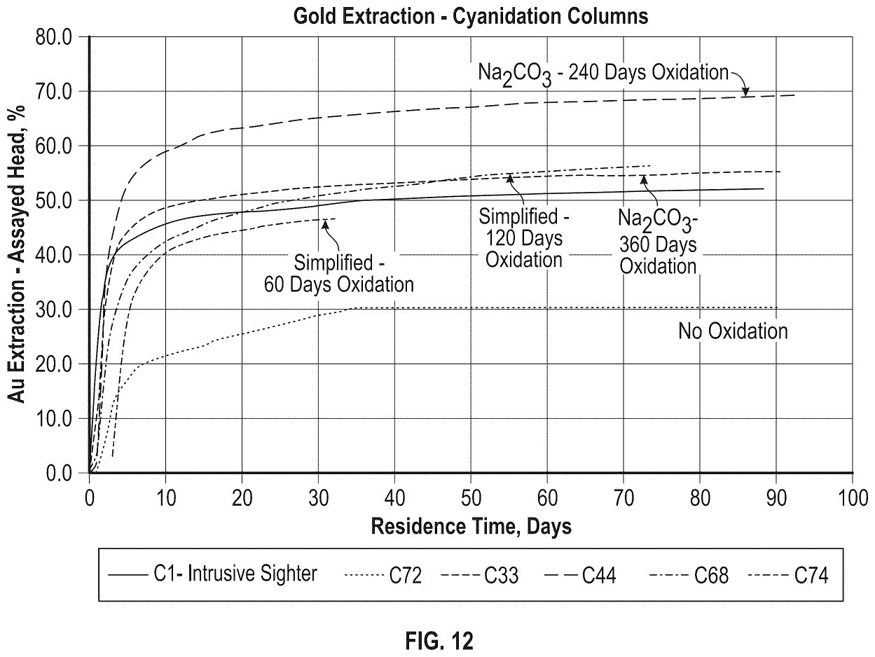

FIG. 12 shows gold extraction of massive intrusive gold-bearing material oxidized in the presence of sodium carbonate and a simplified alkali mixture. Higher percentages of gold are extracted from oxidized material than from non-oxidized material.

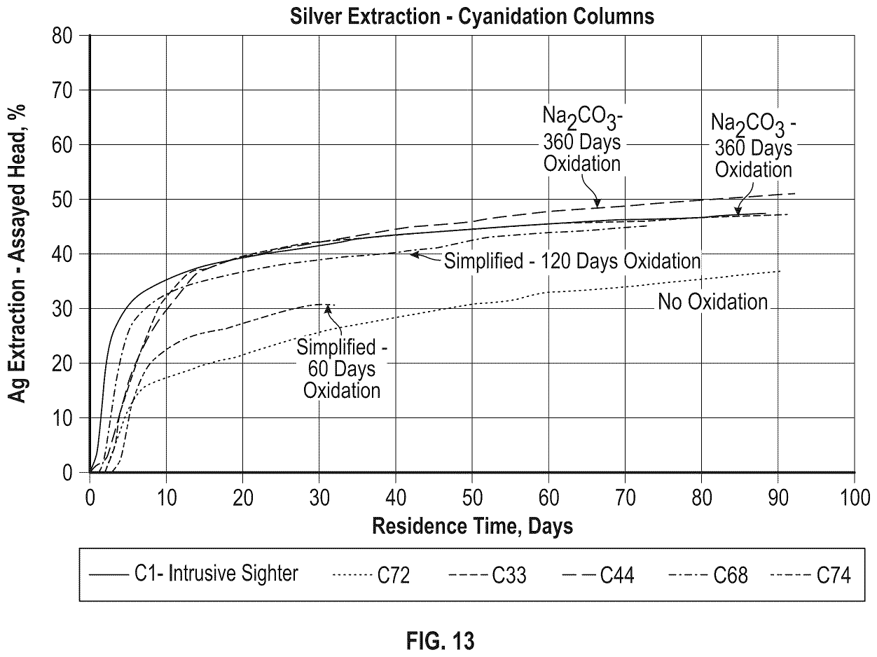

FIG. 13 shows silver extraction of massive intrusive gold-bearing material oxidized in the presence of sodium carbonate and a simplified alkali mixture. Higher percentages of silver are extracted from oxidized material than from non-oxidized material.

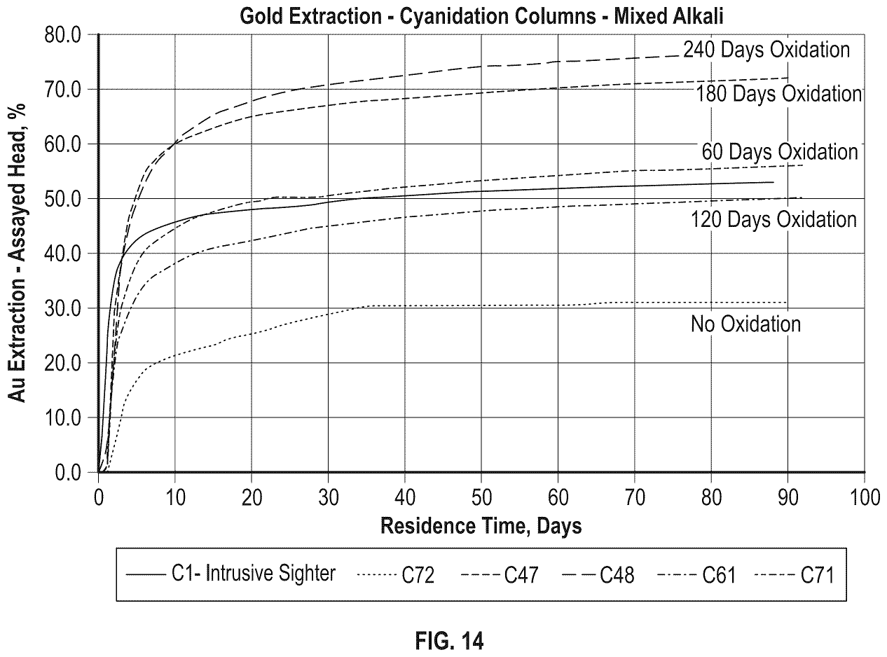

FIG. 14 shows gold extraction of massive intrusive gold-bearing material oxidized in the presence of an alkali mixture. Higher percentages of gold are extracted from material oxidized by mixed alkalis than from non-oxidized material.

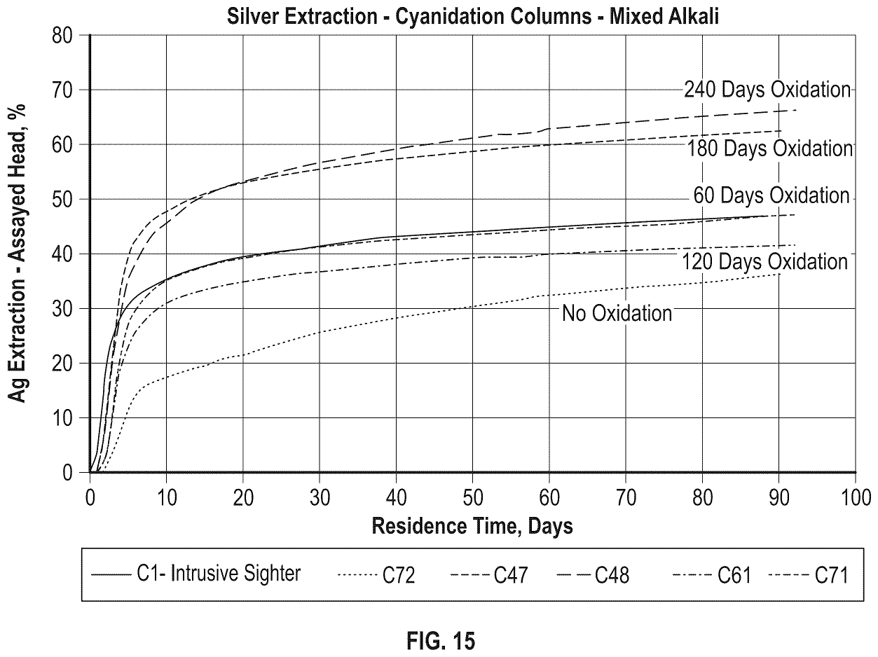

FIG. 15 shows silver extraction of massive intrusive gold-bearing material oxidized in the presence of an alkali mixture. Higher percentages of silver are extracted from material oxidized in the presence of mixed alkalis than from non-oxidized material.

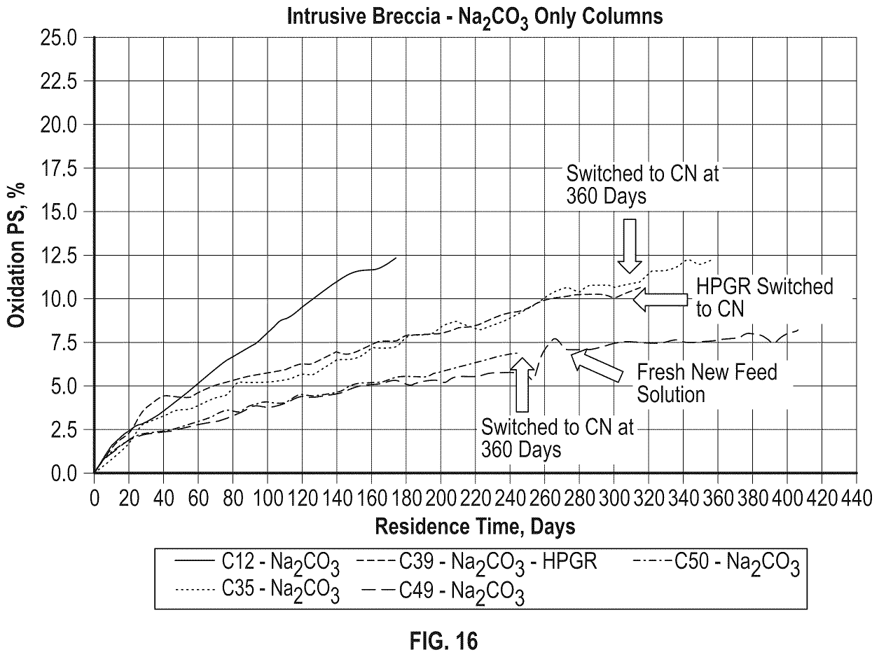

FIG. 16 shows intrusive breccia gold-bearing material oxidized in the presence of sodium carbonate. All intrusive breccia columns exhibit a level of oxidation in the presence of sodium carbonate. The addition of fresh feed solution, e.g., fresh sodium carbonate results in an increase in the amount of material oxidized.

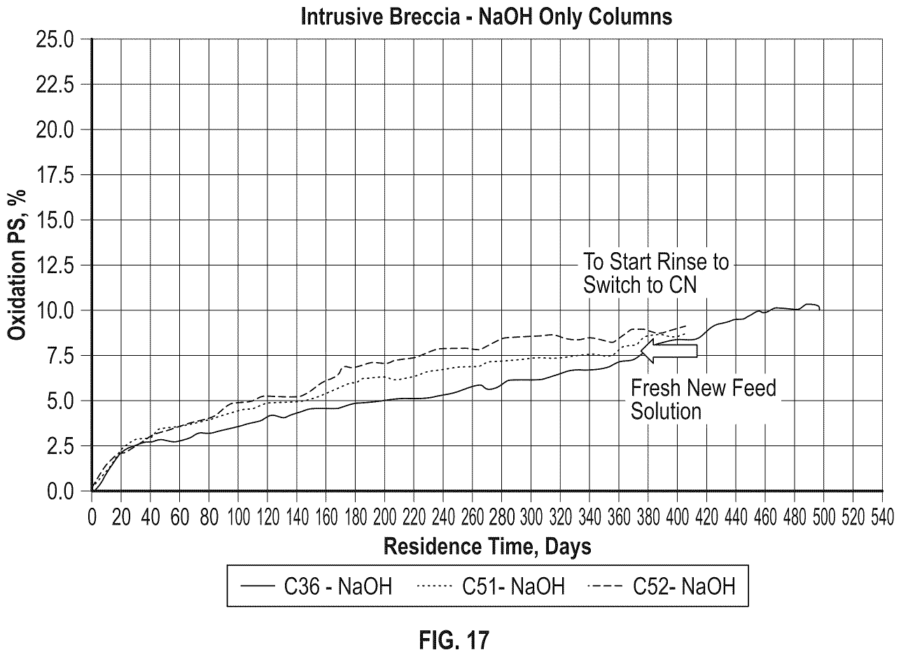

FIG. 17 shows intrusive breccia gold-bearing material oxidized in the presence of sodium hydroxide. All intrusive breccia columns exhibit a level of oxidation by sodium hydroxide. The addition of fresh feed solution, e.g., fresh sodium hydroxide results in an increase in the amount of material oxidized.

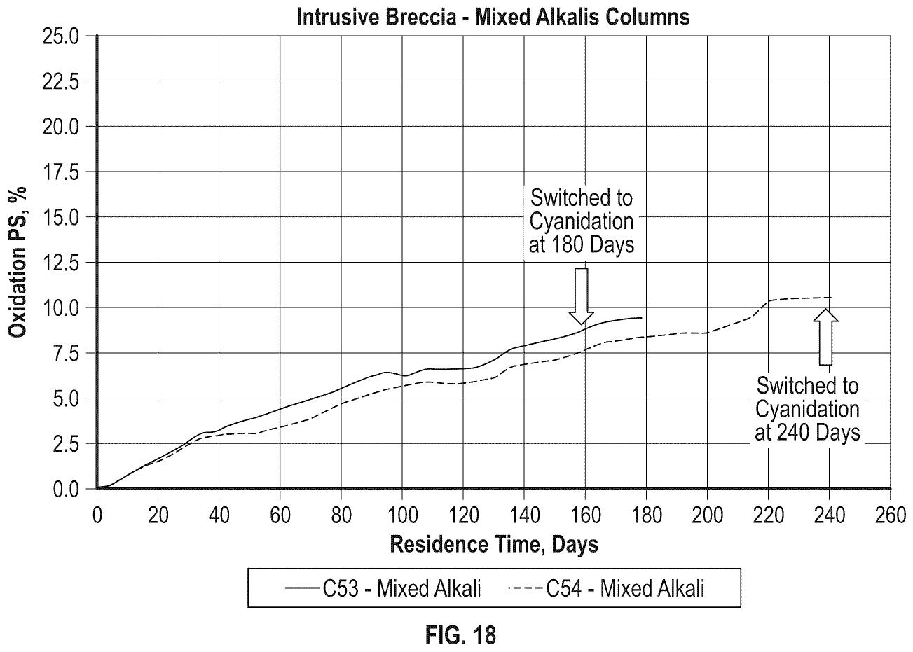

FIG. 18 shows intrusive breccia gold-bearing material oxidized in the presence of an alkali mixture. All intrusive breccia columns exhibit a level of oxidization by the mixed alkali solution.

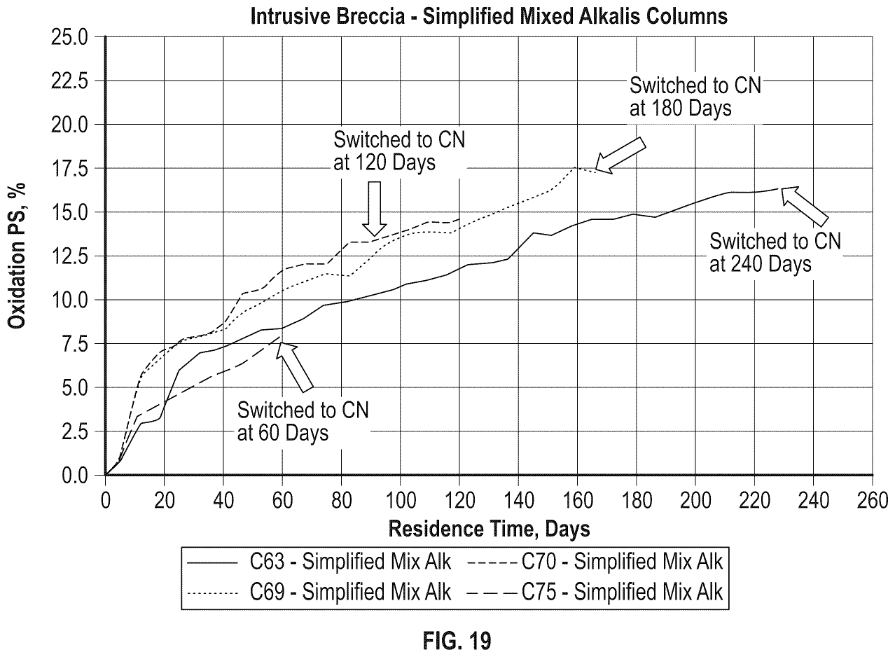

FIG. 19 shows intrusive breccia gold-bearing material oxidized in the presence of a simplified alkali mixture. All intrusive breccia columns exhibit a level of oxidization by the simplified mixed alkali solution.

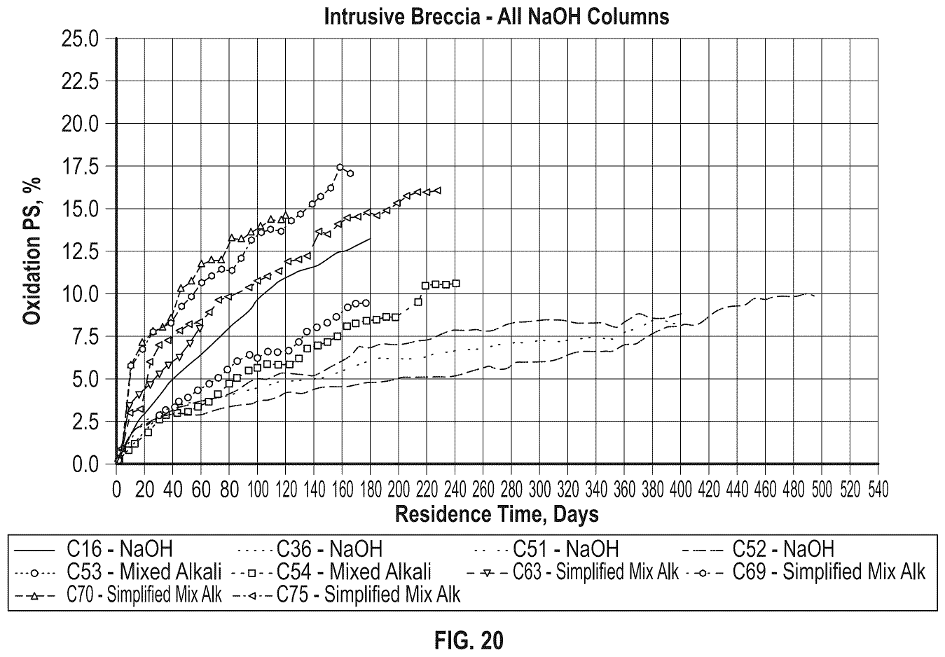

FIG. 20 shows intrusive breccia gold-bearing material oxidized in the presence of sodium hydroxide, an alkali mixture, or a simplified alkali mixture. All intrusive breccia columns exhibit a level of oxidization by the sodium hydroxide, alkali mixture, or simplified alkali mixture.

The method may comprise contacting a material with an oxidizing agent. The oxidizing agent may comprise oxygen, a source of ion (e.g., Fe³⁺), ions, air, forced air, ozone, carbon dioxide, or a combination thereof. The oxidizing agent may comprise a source of ions capable of oxidizing a material.

The concentration of the alkali at any step in the method may be any suitable concentration. Prior to the material being contacted with the alkali, the alkali may be at a concentration of about 0.001 gram per kilogram (“g/kg”) to about 150 g/kg, about 0.01 g/kg to about 125 g/kg, about 0.1 g/kg to about 100 g/kg, about 1 g/kg to about 75 g/kg, about 10 g/kg to about 50 g/kg of alkali solution. The concentration of NaOH may be at least about 0.001 grams per liter (“g/L”), about 0.001 g/L to about 40 g/L, about 0.01 g/L of alkali solution. The alkali solution may comprise any monovalent group I metal ion including, but not limited to, lithium (Li), potassium (K), sodium (Na), or a combination thereof. A lower concentration of alkali may be used.

Contacting of the material with alkali may be carried out under any suitable temperature and pressure conditions. For example, the alkali may be contacted with the material at a temperature of at least about 0 degrees Celsius (“C”), about 0° C. to about 80° C., about 10° C. to about 70° C., about 15° C. to about 60° C., about 20° C. to about 50° C., about 30° C. to about 40° C., or about 80° C.

The method may comprise oxidation in an alkali, e.g., an alkaline or basic solution. The method may comprise contacting a material with an alkali to oxidize the material and/or allow the oxidation of the material. The alkaline solution may comprise a pH of at least about 7, about 7 to about 14, about 8 to about 13, about 9 to about 12, about 10 to about 11, or above 14. The alkaline solution may include, but is not limited to, ammonia; ammonium and/or ammonium containing compounds; carbonate and/or carbonate containing compounds; hydroxide and/or hydroxide containing compounds; sulfate; calcium; sodium; or combinations thereof.

The method may comprise physically processing the material. The material may be physically processed by crushing, grinding, milling, comminuting, high-pressure grinding rolls (“HPGR”), or a combination thereof. The material may be physically processed to yield a particle and/or fragment size in the range of about 20 microns (“μm”), about 20 μm to 1 about meter (“m”), about 40 μm to about 0.75 m, about 100 μm to about 0.5 m, about 500 μm to about 0.25 m, about 1000 μm to about 0.1 m, 5 millimeters (“mm”) to about 0.05 m, or about 1 m.

The method may comprise agglomerating a material. The material may be agglomerated with an alkali. The alkali may include, but is not limited to, sodium carbonate, sodium hydroxide, calcium oxide, or a combination thereof. The material may be agglomerated before and/or after the oxidation stage. The method may comprise crushing a material. The crushed material may be agglomerated. The crushed material may be agglomerated with an agglomeration aid. The agglomeration aid may comprise an inorganic and/or organic compound. The agglomeration aid may improve the stability of the material and/or a heap of the material and/or may maintain permeability during oxidation of the material. The agglomeration aid may also be used in a leaching process after the oxidation stage.

The method may comprise contacting the material with a binder. The material may be contacted with the binder during agglomeration. The binder may include, but is not limited to, cement, clay, e.g., bentonite or kaolinite, lime, a polymer, or combination thereof.

The method may comprise curing the material. The material may be cured by contacting the material with an alkali. The alkali may be at a concentration of about 0.001 gram per kilogram (“g/kg”) to about 150 g/kg, about 0.01 g/kg to about 125 g/kg, about 0.1 g/kg to about 100 g/kg, about 1 g/kg to about 75 g/kg, about 10 g/kg to about 50 g/kg of alkali solution. The concentration of alkali (e.g., NaOH, carbonate, oxygen, air, or a combination thereof) may be at least about 0.001 grams per liter (“g/L”), about 0.001 g/L to about 40 g/L, about 0.01 g/L of alkali solution. Curing may promote or allow oxidation of the material.

The cure residence time may be at least about 3 minutes, about 3 minutes to about 4 years, about 30 minutes to about 3.5 years, about 1 hour to about 3 years, about 12 hours to about 2.5 years, about 24 hours to about 2 years, about 1 week to about 1.5 years, about 1 month to about 1 year, about 3 months to about 9 months, or about 4 years. The cure may comprise contacting the material with a monovalent group I metal ion including, but not limited to, lithium, sodium, potassium, calcium, or a combination thereof.

The method may comprise oxidizing the material. Oxidizing the material may comprise contacting the material with an alkali. The alkali may be an alkali mixture or an alkali from a simplified alkali mixture. The alkali solution may comprise carbonate, e.g., calcium carbonate, hydroxide, e.g., sodium hydroxide, calcium oxide, or a combination thereof. Alkali solutions may include, but are not limited to, NaOH alone; NaOH in combination with Na₂CO₃; and a simplified alkali mixture wherein NaOH is contacted with material cured with Na₂CO₃.

The alkali may be at a concentration of about 0.001 gram per kilogram (“g/kg”) to about 150 g/kg, about 0.01 g/kg to about 125 g/kg, about 0.1 g/kg to about 100 g/kg, about 1 g/kg to about 75 g/kg, about 10 g/kg to about 50 g/kg of alkali solution. The concentration of NaOH may be at least about 0.001 grams per liter (“g/L”), about 0.001 g/L to about 40 g/L, about 0.01 g/L of alkali solution. Oxidation may promote or allow oxidation of the material. Oxidation may occur at a basic pH. The pH may be at least about 7 to about 14, about 8 to about 13, about 9 to about 12, about 10 to about 11, or about 14. The oxidation may comprise contacting the material with a monovalent group I metal ion including, but not limited to, lithium, sodium, potassium, calcium, or a combination thereof.

The oxidation may comprise flowing an alkali through a material. The flow rate may be at least about 0.1 liter per square meters per hour (“L/m²/hr”), about 0.1 L/m²/hr to about 20 L/m²/hr, about 0.5 L/m²/hr to about 18 L/m²/hr, about 1 L/m²/hr to about 16 L/m²/hr, about 2 L/m²/hr to about 14 L/m²/hr, about 6 L/m²/hr to about 12 L/m²/hr, about 8 L/m²/hr to about 10 L/m²/hr, or about 20 L/m²/hr.

The alkali residence time may be at least about 3 minutes, about 3 minutes to about 4 years, about 30 minutes to about 3.5 years, about 1 hour to about 3 years, about 12 hours to about 2.5 years, about 24 hours to about 2 years, about 1 week to about 1.5 years, about 1 month to about 1 year, about 3 months to about 9 months, or about 4 years.

The oxidation may comprise contacting the material with an oxidizing agent. The oxidizing agent may comprise oxygen, air, forced air, peroxide, ozone, or a combination thereof. The oxidation may consume alkali. Substantially all of the alkali may be consumed by the oxidation.

The oxidation may comprise producing an alkali solution comprising more calcium carbonate compared to NaOH. Fresh reagents may be contacted with the material. For example, fresh NaOH or carbonate may be added to the material to increase oxidation and/or maintain the pH of the alkali solution.

The method may comprise producing bicarbonate to generate a pH buffer. Sodium hydroxide may be returned to the alkali to convert bicarbonate back to sodium carbonate.

Sodium carbonate may solubilize iron in the alkali solution and/or increase oxygen saturation and oxidation potential.

Without being limited by a particular theory, sodium carbonate may increase oxygen saturation and oxidation potential and/or may prevent a passivation layer form forming on the material. Without being limited to a particular theory, a ferric/ferrous couple with carbonate may be formed to solubilize iron and allow oxidation of the material by keeping the surface of the material clear of oxidation products or precipitates. The ferric/ferrous couple may drive the kinetics of the oxidation reaction.

Sulfides may be oxidized to produce a sulfur oxide species, including but not limited to sulfate, sulfite, polythionates, or a combination thereof, during oxidation. Oxidation may release acid that may contact the sulfur oxide species and form an acid compound including, but not limited to H₂SO₃ and/or H₂SO₄. These acids may then be neutralized by alkalis to produce Na₂SO₃ and/or Na₂SO₄. The sulfites and other polythionates may eventually oxidize to sulfate.

The method may comprise regenerating a reagent. The reagent may be NaOH and/or Na₂CO₃. NaOH may be regenerated by contacting NaSO₄ and/or NaHCO₃ with a source of hydroxide, e.g., Ca(OH) 2. The reagent may be regenerated according to Equations (1), (2), and (3):

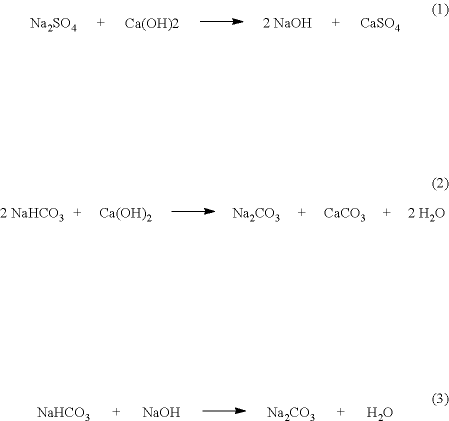

The regeneration process may also yield NaHCO₃ and Na₂CO₃, which are generated from solution contact with the atmosphere. The regeneration reaction may not react all of the Na₂SO₄, which may be returned to the alkali. The CaSO₄ product may be used in the manufacture of gypsum and/or drywall.

Reagent regeneration may occur at any pH. The pH may be slightly acidic to slightly basic. The pH may be at least about 4, about 4 to about 14, about 8 to about 13, about 9 to about 12, about 10 to about 11, or about 14.

The method may comprise grinding calcium and/or a calcium compound. The ground calcium and/or calcium compound may be contacted with the material. The calcium and/or calcium compound may be contacted with the material during curing and/or oxidation or with solution for regeneration.

An alkali solution may be produced after the alkali is contacted with the material. The alkali solution may comprise a depleted alkali and/or an oxidation product. The alkali solution may be regenerated with lime and/or other alkali to precipitate the oxidation products and/or produce a refreshed alkali solution. The refreshed alkali solution may be recycled to the oxidation process.

The regeneration process may be performed in a series of regeneration vessels. Each of the series of regeneration vessels may comprise a suspension of lime (milk of lime), other alkali, a solution of alkali, or a combination thereof. A slurry comprising the alkali and the material from a downstream vessel in the series of regeneration vessels may be recycled to an upstream regeneration vessels. The recycling may provide alkalinity and/or nucleation seeds for a precipitation process. A thickener may be added to and/or after neutralization process to clarify a regenerated solution in the regeneration process. Contact with the thickener may produce a thickener underflow from regeneration vessel. At least a portion of the thickener underflow may be sent back to the neutralization process to provide nucleation seeds and/or alkalinity.

The method may comprise extracting metal from a material. The metal may be extracted by contacting the material with a lixiviant. The lixiviant may leach the metal from the material. The lixiviant may comprise cyanide, sodium cyanide, potassium cyanide, ammonium cyanide, acetonitrile thiourea, or a combination thereof. The metal may be extracted by cyanidation. The concentration of the lixiviant may be in the range of at least about 0.1 g/L, about 0.1 g/L to about 10 g/L, about 0.5 g/L to about 9.5 g/L, about 1 g/L to about 9 g/L, about 1.5 g/L to about 8.5 g/L, about 2 g/L to about 8 g/L, about 2.5 g/L to about 8 g/L, about 3 g/L to about 7.5 g/L, about 3.5 g/L to about 7 g/L, about 4 g/L to about 6.5 g/L, about 5 g/L to about 6 g/L, or about 10 g/L. The concentration of the lixiviant may be in the range of at least about 0.1 millimolar (“mM”), about 0.1 mM to about 100 mM, about 1 mM to about 90 mM, about 5 mM to about 80 mM, about 10 mM to about 70 mM, about 20 mM to about 60 mM, about 30 mM to about 50 mM, or about 100 mM.

The lixiviant residence time may be at least about 3 minutes, about 3 minutes to about 4 years, about 30 minutes to about 3.5 years, about 1 hour to about 3 years, about 12 hours to about 2.5 years, about 24 hours to about 2 years, about 1 week to about 1.5 years, about 1 month to about 1 year, about 3 months to about 9 months, or about 4 years.

Cyanidation may occur at a pH of at least about 10, about 10 to about 14, about 10.5 to about 13.5, about 11 to about 13, about 11.5 to about 12.5, about 11 to about 12, or about 14. Iron (e.g., pyrite) may be removed prior to cyanidation to liberate the metal from the material.

The lixiviant may comprise an acidic solution. The acidic solution may comprise thiourea to extract a precious metal from the material. The lixiviant may also comprise a halide ion including, but not limited to, chloride, bromide, iodide, or a combination thereof.

The method may comprise use of an oxidation pad. The oxidation pad may comprise a plurality of cells. The cells may comprise a cure cell, an initial irrigation cell, an irrigation cell, and/or a rinse cell. A cell may be transitioned into another cell based on the reagent contacted with material in the cell. For example, a cure cell may be transitioned to a leach cell once it is irrigated or if NaOH is added to the cell. Material may or may not be transferred between cells. The cells may be transitioned in sequence. For example, a cure cell may be transitioned to an initial irrigation cell, an initial irrigation cell may be transitioned to an irrigation cell, and an irrigation cell may be transitioned to a rinse cell. Each cell may comprise a plurality of layers. Each layer may be oxidized separately or in sequence.

The method may comprise use of a leach pad. The leach pad may be a separate pad than the oxidation pad. The method may comprise moving material from the oxidation pad to the leach pad. Alternatively, the oxidation pad may be converted to a leach pad and material may remain in the oxidation pad before it is contacted with a lixiviant. The leach pad may be an on/off leach pad.

The method may comprise deep injection of an alkali into an oxidation pad and/or deep injection of a lixiviant into a leach pad. Deep injection may prevent reagent consumption by a secondary oxidation and/or reaction. The method may comprise supersaturating an alkali or lixiviant solution in the oxidation and leach pads, respectively.

The method may be a batch process, a continuous process, or a combination thereof. The method may be an in situ batch process, a continuous process, or a combination thereof.

The material can be contacted with the alkali using any suitable process known in the art. The material may be contacted with the alkali in a method comprising a percolation oxidation (e.g., a dump leach, column leach, heap leach or a combination thereof), agitated oxidation, a tank oxidation, a vat oxidation, a bioreactor, or a combination thereof. Suitable processes, means and/or conditions for carrying out a percolation oxidation (e.g., a dump leach, column leach, heap leach or a combination thereof), agitated oxidation, a tank oxidation, a vat oxidation or an oxidation in a bioreactor may be selected by the person skilled in the art.

The material can be contacted with the alkali, the selection of which can be made by a person skilled in the art. The material may be contacted with the alkali in a percolation leach (e.g., a dump leach, column leach, heap leach or a combination thereof), an agitated leach, a tank leach, a vat leach, a bioreactor, or a combination thereof. Suitable processes, means and/or conditions for carrying out a percolation leach (e.g., a dump leach, column leach, heap leach or a combination thereof), an agitated leach, a tank leach, a vat leach or a leach in a bioreactor in the processes of the present invention may be selected by the person skilled in the art.

Any step of the method may be performed at temperature of at least about 4° C., about 4° C. to about 60° C., about 10° C. to about 55° C., about 15° C. to about 50° C., about 20° C. to about 45° C., about 25° C. to about 40° C., about 30° C. to about 35° C., or about 60° C.

The method may comprise rinsing the material. The material may be rinsed with a solvent including, but not limited to, water, an aqueous solution, a salt solution, deionized water, distilled water, or a combination thereof. The rinse may remove sulfate from the material or a solution in contact with the material.

The method may recover metal from the rim (the exterior surface), and/or interior of the material. Greater oxidation of the material may yield greater metal recovery. The method may oxidize at least about 5%, about 5% to about 90%, about 10% to about 80%, about 15% to about 75%, about 20% to about 70%, about 25% to about 65%, about 30% to about 60%, about 35% to about 55%, about 40% to about 50%, or about 90% of the material. The method may recover at least about 5%, about 5% to about 99%, about 10% to about 80%, about 15% to about 75%, about 20% to about 70%, about 25% to about 65%, about 30% to about 60%, about 35% to about 55%, about 40% to about 50%, or about 99% of the metal from a material.

The method may generate heat and may comprise an exothermic reaction. The heat may be generated in an alkaline environment.

The oxidized material may be porous and/or comprise interstitial spaces through which an alkali solution may pass.

The method may comprise use of an interstitial liner. The interstitial liner may be at least partially disposed above, below, around, or between material comprising a metal.

Extracting a metal from the material may produce a pregnant leach solution comprising the metal. The metal may be refined from the pregnant leach solution and/or may be converted to a solid form.

The method may comprise solvent extraction and/or electrowinning to recover and/or collect a metal from a pregnant leach solution. The method may comprise contacting a material, pregnant leach solution, alkali solution, any other fluid, with a reagent at any point in the method to recover the metal.

The metal may be separated from the solution by processes including, but not limited to, a Merrill-Crowe process, columns containing carbon in columns followed by elution and electrowinning, an ion-exchange resins, a countercurrent ion exchange resin, a resin carousel system, or a combination thereof.

The method may comprise contacting the material or alkali with a buffer. The buffer may be used for or at any step of the method. The method may comprise contacting a material or a reagent, e.g., an alkali, with a buffer, e.g., bicarbonate.

Embodiments of the present invention provide a technology-based solution that overcomes existing problems with the current state of the art in a technical way to satisfy an existing problem for the recovery of metal. Embodiments of the present invention achieve important benefits over the current state of the art, such as increased extraction efficiency, greater metal recovery and/or yield, and faster recovery times. Some of the unconventional steps of embodiments of the present invention include curing with an alkali reagent, extraction with an alkali reagent, and regeneration of sodium hydroxide.

The term of degree “substantially” as used herein means a reasonable amount of deviation of the modified term such that the end result is not significantly changed. Note that in the specification and claims, “about” or “approximately” means within twenty percent (20%) of the numerical amount cited. The terms, “a”, “an”, “the”, and “said” mean “one or more” unless context explicitly dictates otherwise. The term “and/or” as used herein means that the listed items are present, or used, individually or in combination. In effect, this term means that “at least one of” or “one or more” of the listed items is present or used.

Any of the above embodiments may be used in combination with, or may comprise, an alkali.

All percentages are by weight. Unless otherwise indicated, the definitions and embodiments described in this and other sections are intended to be applicable to all embodiments and aspects of the invention herein described for which they would be understood to be suitable by a person skilled in the art.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of recovering a metal, the method comprising:
physically processing a material;
contacting the material with an alkali solution;
oxidizing the material;
regenerating an alkali;
recycling the regenerated alkali to the alkali solution;
contacting the material with a lixiviant to form a pregnant leach solution; and
separating the metal from the pregnant leach solution.

2. The method of claim 1 further comprising agglomerating the material.

3. The method of claim 1 wherein the alkali comprises a carbonate.

4. The method of claim 1 wherein the alkali comprises sodium hydroxide.

5. The method of claim 1 wherein the metal is a precious metal.

6. The method of claim 1 wherein physically processing comprises crushing.

7. The method of claim 1 wherein physically processing comprises high-pressure grinding rolls.

8. The method of claim 1 wherein oxidizing the material comprises contacting the material with an oxidizer.

9. The method of claim 1 wherein the lixiviant comprises cyanide.

10. The method of claim 1 wherein regenerating an alkali comprises producing sodium sulfate.

11. The method of claim 10 wherein regenerating an alkali further comprises contacting sodium sulfate with calcium hydroxide to yield sodium hydroxide.

12. The method of claim 10 wherein regenerating an alkali further comprises contacting bicarbonate with sodium hydroxide to yield sodium carbonate.

13. The method of claim 1 wherein regenerating an alkali further comprises contacting sodium sulfate with calcium hydroxide to yield hydrous calcium sulfate.

14. The method of claim 1 wherein the regenerated alkali is sodium hydroxide.

15. The method of claim 1 wherein the material comprises igneous rock.

16. The method of claim 1 further comprising curing the material.

17. The method of claim 1 wherein the alkali solution comprises more sodium carbonate compared to sodium hydroxide.

18. The method of claim 1 further comprising producing bicarbonate.

19. The method of claim 1 further comprising contacting the material with a calcium compound.

20. The method of claim 1 further comprising precipitating an oxidation product from the alkali solution.
